(19) United States
(12) Patent Application Publication
(10) Pub. No.: US 2005/0011131 A1
(43) Pub. Date: Jan. 20, 2005

(54) Window vent stop

(76) Inventors: Luke K. Liang, Irvington, NJ (US); Tong Liang, Guangzhou (CN)

Correspondence Address: Thomas A. O'Rourke;Bodner & O'Rourke, LLP, 425 Broadhollow Road, Melville, NY, 11747, US

(21) Appl. No.: 10/623,120

(22) Filed: Jul. 18, 2003

(51) Int. Cl. E05F 3/00

(52) U.S. Cl. 49/449

(57) ABSTRACT

The present invention is directed to an improved vent stop for use in a sliding sash window assembly or a sliding door assembly. The vent stop has a housing adapted to be disposed in the recess. This housing includes a cavity with a bottom plate therein. Inside the cavity is a tumbler that may be in a retracted position and an extended position. When the tumbler is in an extended position the tumbler has a protruding apex at the top. The tumbler has at least one pivot means for pivotally securing said tumbler to said housing for movement between the extended position and the retracted position. In the extended position the bottom of the tumbler overlies a portion of the second sash to prevent movement of the lower sash past the tumbler. When in a retracted position within said cavity the sash or door can be raised and/or moved past the tumbler without interference. Also within the housing is a spring means for biasing said tumbler into said extended position and a release member for causing said tumbler to be in a raised position and a lowered position. The tumbler has a first locking member that contacts a second locking member on the release member when the tumbler is in a lowered and said first locking member does not contact the second locking member when the tumbler is in a raised position.

### FIELD OF THE INVENTION

The present invention relates to improved window vent stops particularly for double hung windows and the like and to improvements in their operation. These window vent stops are used prevent a window or door from opening more than a desired amount.

### BACKGROUND OF THE INVENTION

There are a number of different types of window vent stops available on the market. These window vent stops are used to restrict the opening of windows and doors. For example, a window may be opened only a portion due to security concerns or to increase comfort in the room. Window vent stops are primarily used on double hung windows and sliding doors where a sash or a door member slides from a first position to a second position. The window sash lock prevents the sash or the sliding door from moving past a selected point. These sash locks can permit the window to be opened a desired amount for ventilation or other purposes.

There are many different types of windows currently available. These windows include casement windows, transom windows, single hung window, double hung windows, sliding windows, etc. Double hung windows are windows that have a pair of window sashes that may be raised and lowered. Each sash resides in a pair of tracks or recesses that are typically at each side edge of the window. This permits the lower sash to be raised and the upper sash to be lowered. Traditionally, most windows were made of wood, more recently, the windows including the window sashes have been made of extruded metal or plastic.

Single hung windows are similar in design to double hung windows except that there is only one sash that may be raised or lowered. Sliding windows are also not unlike double hung windows in design. While a double hung window has sashes that are raised and lowered, a sliding window has sashes that are movable along a track to the right or left. Similarly, sliding doors operate the same way as sliding windows.

Double hung windows, single hung windows, sliding windows and sliding doors have a variety of open positions in which they may be placed. While a fully opened position can be desirable for ventilation purposes there can be a downside to the fully opened position. One downside is security. A fully open window or door, however, can be a location for unauthorized ingress and egress from the premises. For example, a double hung window that is opened wide can be a source of danger to small children who may climb up to the window. As a result, many municipalities have enacted laws requiring window guards. Additionally, an opened window or door can provide an invitation to third parties to gain access to the building. As a result, there are a number of vent stops that are available to secure a window or door having sliding members in a partially opened position. One such stop is shown in U.S. Pat. No. 5,248,174 owned by Ashland Products. Another sash stop is shown in U.S. Pat. No. 4,923,230 owned by Ro Mai. In each of these sash stops there is a spring biased tumbler or dog that pivots from an unlocked position to a locked position as desired. These sash locks are positioned in the frame of the upper sash and when the tumbler is pivoted outwardly the position of the tumbler prevents the lower sash from being raised above a preselected position. Other prior art patents for similar products a U.S. Pat. Nos. 5,553,903 and 5,806,900 both of which are owned by Ashland.

The typical prior art sash lock operates by a tumbler that is activated by pushing downwardly on the tumbler. The tumbler in the prior art sash locks has a catch portion that contacts the underside of the sash lock housing in a closed position. When the sash lock is intended to be activated, the tumbler is moved in a transverse direction opposite the location of the catch portion to release the catch from the housing. The spring in the sash lock causes the tumbler to be raised into an activated position to lock the sash or door in position, and moving the tumbler in a transverse direction to activate the operation of the tumbler.

One of the problems in the operation of the prior art sash locks is that it is frequently difficult for the user to move the tumbler away from the housing to release the tumbler from its recessed position. This is particularly true where the spring that causes the tumbler to be raised is new and/or relatively strong. Many times, the user finds it difficult to maneuver the tumbler away from the housing to release the tumbler. Although many tumblers are provided with surfaces that increase the user's ability to move the tumbler this surface is frequently insufficient to overcome the difficulties of the prior art vent locks.

Similarly, the prior art sash locks can also be difficult to operate when the user wants to release the window or door for travel. The user must not only push down on the tumbler to release the sash but also must shift the tumbler so that it catches the catch portion of the housing. If the catch portion of the housing is not contacted by the tumbler, the tumbler will be raised due to the pressure of the spring and the sash will not be permitted to move.

While the vent stops of the prior art are generally satisfactory in operation there is also a need for improved vent stops. The problems of the prior art stops is solved by the vent stop of the present invention which operate in a unique manner compared to the traditional sash locks.

### OBJECTS OF THE INVENTION

It is an object of the present invention to provide a vent stop that operates more easily than the prior art vent stops.

It is an object of the present invention to provide an improved vent stops that is more dependable in its operation than the prior art vent stops.

It is an object of the present invention to provide a vent stop that provides a mechanism that permits the tumbler to be retained in a recessed position more readily than the prior art vent stops.

It is still another object of the present invention to provide a vent stop that is more readily placed in a locking position by a user without having to shift the tumbler away from the catch portion of the housing.

It is a still further object of the present invention to provide a vent stop that has a tumbler that is less likely to become separated from the vent stop housing during use than prior art vent stops.

### SUMMARY OF THE INVENTION

The present invention is directed to an improved vent stop or sash lock for use in a sliding sash window assembly or a sliding door assembly. The window may have one or more sashes usually an upper and lower sash window frames installed for vertical sliding movement. Alternatively, the window may have a left and right horizontal sliding sashes. The door may also have one or more sliding doors. One sash frame or sliding door frame has a recess into the interior thereof. The vent stop has a housing adapted to be disposed in the recess.

This housing includes a cavity with a bottom plate therein. Inside the cavity is a tumbler that may be in a retracted position and an extended position. When the tumbler is in an extended position the tumbler has a protruding apex at the top. The apex prevents a sash or door from moving when the apex contacts the sash or the door. The tumbler has at least one pivot means for pivotally securing said tumbler to said housing for movement between the extended position and the retracted position. In the extended position the bottom of the tumbler overlies a portion of the second sash to prevent movement of the lower sash past the tumbler. When in a retracted position within said cavity the sash or door can be raised and/or moved past the tumbler without interference. Also within the housing is a spring means for biasing said tumbler into the extended position. The tumbler has at least one means for retaining the tumbler within the housing. The retaining means may be one or more pins that extend laterally from the side of the tumbler and ride within an opening in the sidewall of the housing. Alternatively, the interior wall of the housing may have one or more pins extending toward the tumbler and riding within an opening in the tumbler's side wall.

### BRIEF DESCRIPTION OF THE DRAWINGS

FIG. 1 is a bottom view of the housing of the vent stop of the present invention.

FIG. 2 is a side view of the housing of FIG. 1.

FIG. 3 is an top view of the housing of FIG. 1.

FIG. 4 is a side view of the of the opposite side of the housing of FIG. 2.

FIG. 5 is an end view of the housing of the vent stop of FIG. 1.

FIG. 6 is a side view of the opposite side of the vent stop of FIG. 1.

FIG. 7 is a perspective view of the vent stop of FIG. 1 with the tumbler removed

FIG. 8 is a side view of the tumbler of the vent stop of the present invention.

FIG. 9 is a top view of the tumbler of FIG. 6.

FIG. 10 is a cross sectional view of the tumbler of FIG. 8 taken along A-A.

FIG. 11 is a sectional view of the tumbler of FIG. 8 as viewed from B-B.

FIG. 12 is a perspective view of the tumbler of FIG. 8.

FIG. 13 is a side view of the release mechanism of the vent stop of FIG. 1

FIG. 14 is an end view of the release mechanism of FIG. 13.

FIG. 15 is a side view of a portion of the top of the release mechanism of FIG. 10.

FIG. 16 is a perspective view of the release mechanism of FIG. 10.

FIG. 17 is a side view of the spring of the vent stop of FIG. 1.

FIG. 18 is an end view of the spring of FIG. 17.

FIG. 19 is a perspective view of the releasing button of the vent stop of FIG. 1.

FIG. 20 is a top view of the button of FIG. 19.

FIG. 21 is a side view of the button of FIG. 19.

FIG. 22 is a bottom view of the button of FIG. 19.

FIG. 23 is an end view of the button of FIG. 19.

FIG. 24 is a cutaway view of the button of FIG. 19 taken along C-C of FIG. 21.

FIG. 25 is an enlarged view of the portion A of FIG. 21.

FIG. 26 is an enlarged view of the portion B of FIG. 21.

FIG. 27 is a side view of the button of FIG. 19 opposite the side of FIG. 21.

FIG. 28 is a side sectional view of the vent stop of the present invention with the tumbler in a recessed position.

FIG. 29 is a side view of the vent stop of FIG. 28 in solid form.

FIG. 30 is a top view of the vent stop of FIG. 29.

FIG. 31 is a perspective view of the vent stop of FIG. 29.

FIG. 32 is an end view of the vent stop of FIG. 29.

### DETAILED DESCRIPTION OF THE PRESENT INVENTION

The window or door assembly that may employ the vent stop of the present invention may be a conventional double hung window, a single hung window, sliding window, sliding door and the like. For convenience the present invention will be described with reference to a double hung window but the same applies to each of the above other types of windows and doors having at least one sliding member. The double hung window usually includes upper and lower sash window frames, that are provided with suitable glazing to protect and bed the glass. The sashes are conventionally mounted within a main jamb frame for vertical reciprocal sliding movement therein. Sliding windows and doors are mounted for horizontal reciprocal sliding. Both the jamb frame and the sashes and can be formed of different materials, such as metal or strong and rigid plastics well known in this field. The sashes and are preferably fabricated from elongate framing members of hollow configuration and are generally rectangular in cross-section and rectilinear in configuration, but the shapes and configurations can vary. The upper sash includes a stile, and the lower sash includes a header having an upper exterior surface. The vent stop of the present invention is designated generally in FIGS. 14 and 15 by reference numeral 10. This vent stop may be installed in the exterior front surface of the sash stile, and engaging the upper exterior surface of the header of the lower sash, in its locking position. It will be appreciated that the vertical location of the vent stop in the stile will depend upon the amount of vertical movement of the lower sash that is desired before the upper header surface engages the vent stop.

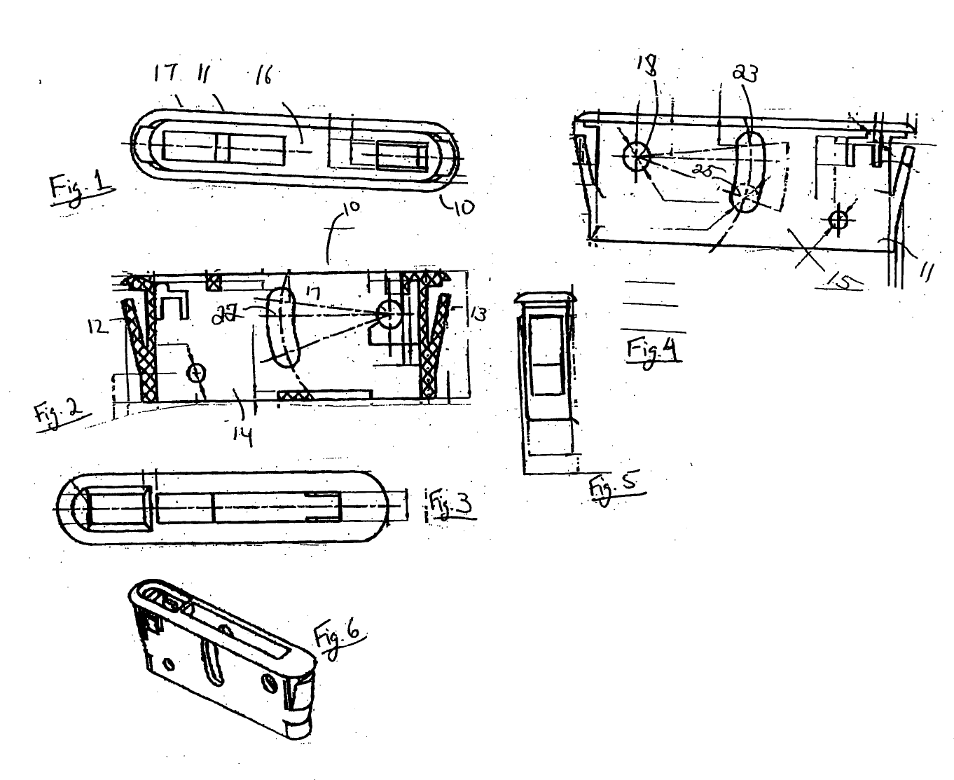

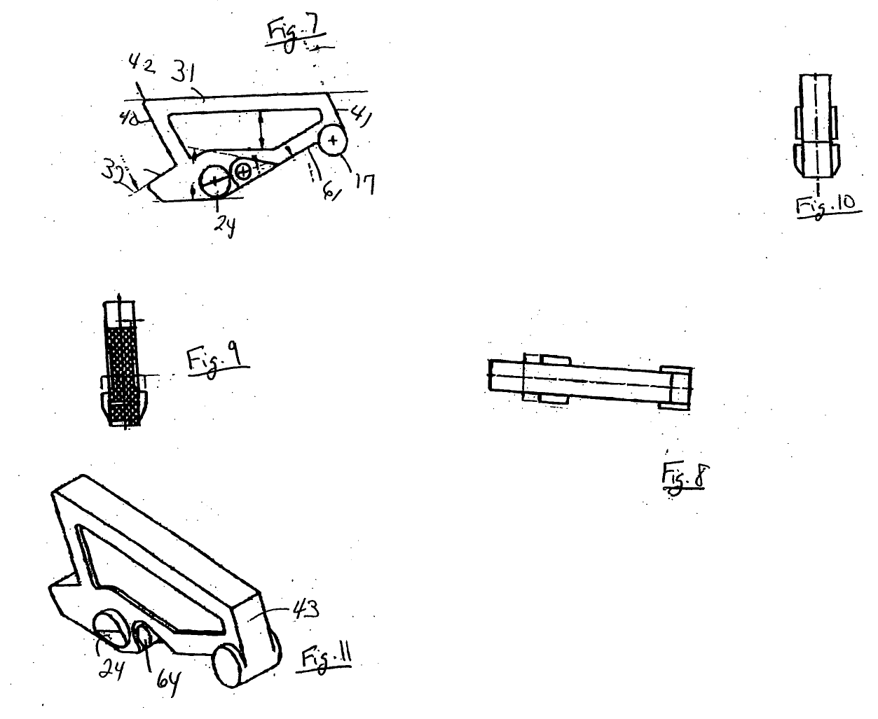

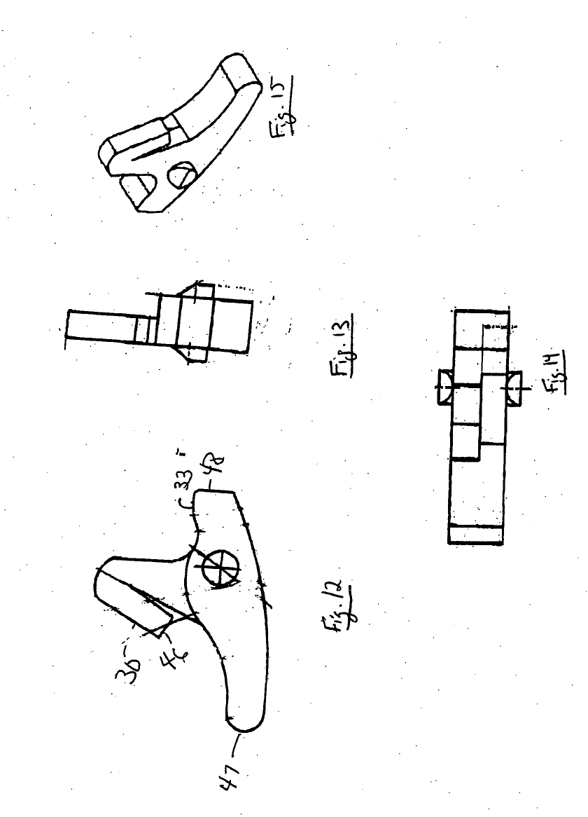

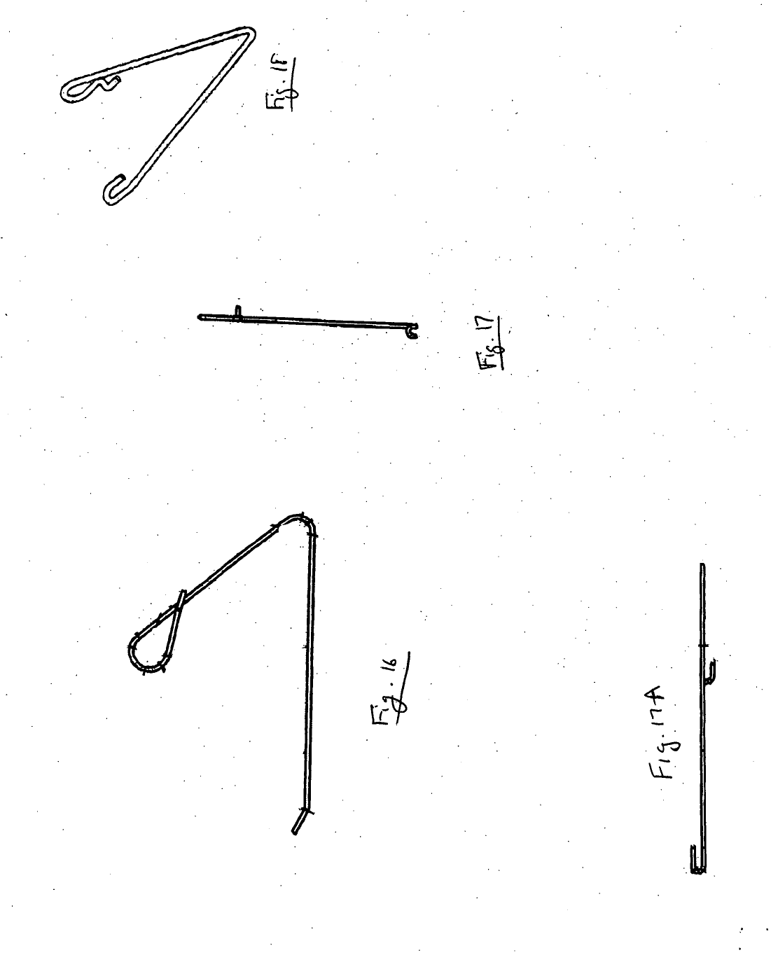

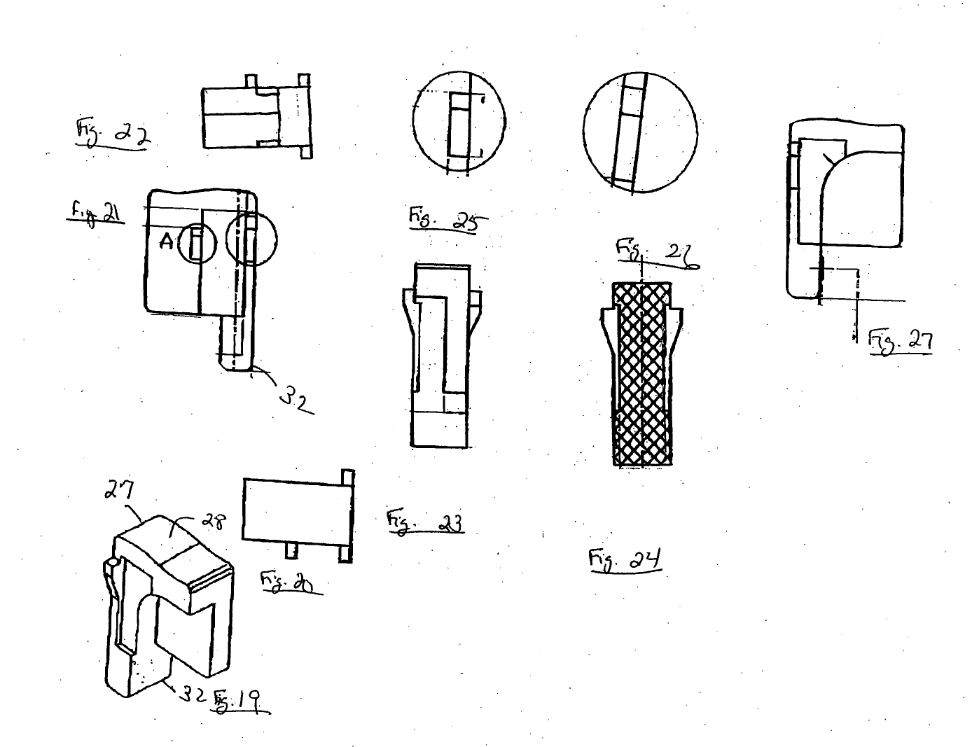

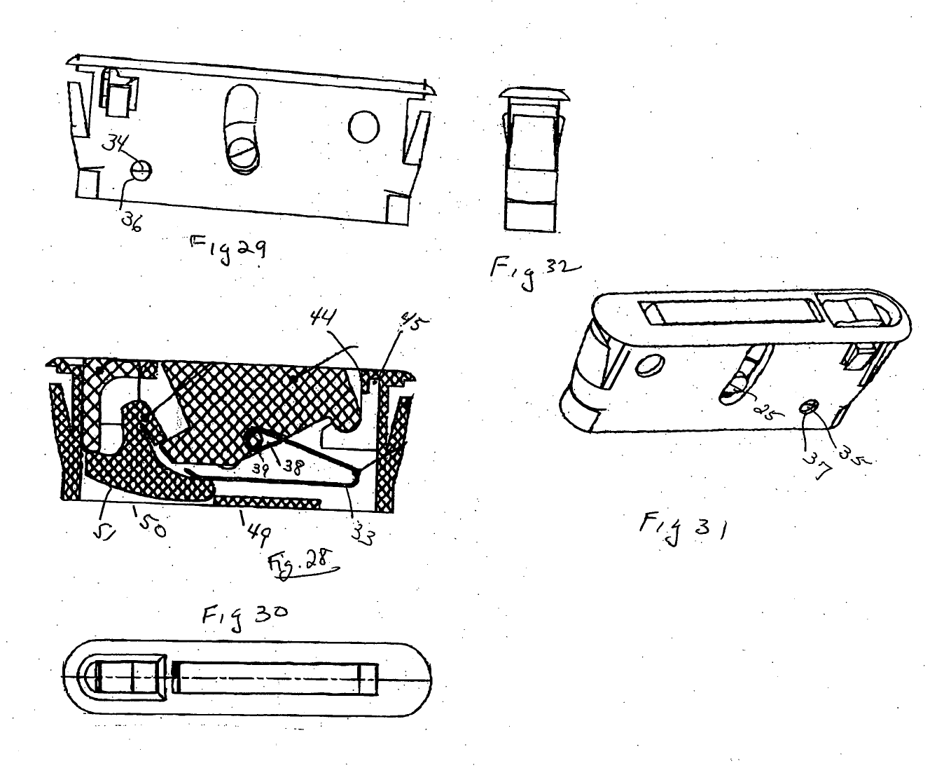

The vent stop 10 includes a housing 11 shown in FIG. 1 that retains the mechanism of the stop. The housing is installed in an opening or recess in the front surface of the sash stile. The housing 11 may have a front wall 12, rear wall 13 and side walls 14 and 15. On the top surface of the housing is a faceplate 16 which has a lip portion 17 that overlaps the peripheral edge of the recess to support the housing 11 therein and to furnish an attractive exterior appearance and protect any rough edges in the opening in the sash stile. The front wall 12, the rear wall 13 and the side walls 14 and 15 extend downwardly from the under surface of the faceplate 16. The side walls 14 and 15 are each provided with an opening 17 and 18 respectively for receiving pivot members 19 and 20 on the tumbler 21. It will be appreciated that alternatively, the tumbler 21 may be provided with openings 17 and 18 and the housing with the pivot members 19 and 20. Similarly, although the openings 17 and 18 preferably extend completely through the sidewall of the housing they do not have to, provided the opening is deep enough to retain the pivot members in position.

The side walls 14 and 15 of the housing are also provided with a recessed track 22 and 23. The recessed track is generally in the form of an arc and the track is intended to receive retaining members 24 and 25 that extend from the tumbler 60. The retaining members 24 and 25 typically govern the amount of travel permitted to the tumbler and help retain the tumbler within the housing. As was the case with the openings 17 and 18, the tumbler 21 may alternatively be provided with the recessed tracks 22 and 23. In such embodiment, the interior of the side walls 14 and 15 of the housing may be provided with the retaining members 24 and 25.

Also contained within the housing 11 is the button 27. The button 27 has a top surface 28 that the operator manipulates in operating the vent lock. Typically, the button 27 is pushed inwardly to pivot the release member 29. The pin 32 on the underside of the button contacts the top surface 33 of the release member 29. As the release member 29 pivots, head 30 moves upwardly thereby releasing the tip 32 of the tumbler 31. When the head 30 rises off of the tip 32, the spring 33 forces the tumbler 21 upwardly in to a locking position. The release member 29 is provided with a first pin 34 and a second pin 35 that may be received by orifices 36 and 37 in the sidewalls of the housing.

The tumbler is preferably provided with a recessed portion 38 for receiving one end 39 of the spring 33. The tumbler has a front portion 40 and a rear portion 41. The first tip 32 rises upwardly when the tumbler is released and contacts the underside 45 of the top surface 16 of the housing. The second tip 42 of the front portion extends upwardly above the top surface 16 of the vent stop housing and prevents the sash from moving while the tumbler is raised. The rear portion 41 of the tumbler has a generally flat surface 43 that contacts tab 44 that extends downwardly from the underside 45 of the top surface 16. This tab 44 provides additional support to further prevent the tumbler from extending a further distance from the housing.

The release member is preferably generally in the shape of an inverted “T”. There is a head 30 that is generally in the form of an inverted “U” having a strike surface 46. The release member has a first base end 47 and a second base 48. On the second base end of the release member is the top surface 33 that is contacted by the pin 32 on the button 27. The release member pivots about pins 34 and 35. The underside 49 of the housing 11 is provided with an opening 50 over a portion of its surface. The underside 51 of the release member may extend a short distance below the surface of the underside of the housing when said tumbler is in a lowered position.

The front wall 12 and the rear wall 13 preferably have one or more retaining pins 52 and 53 that extend outwardly from the exterior surface of the housing members. Similarly, the side walls 14 and 15 of the housing may also have one or more retaining pins 54 and 55 extending therefrom. These pins 52-55 are preferably flexible and give slightly to permit the vent stop to be inserted into the opening in the sash. The gap 56 between the underside 17 of the faceplate 16 and the upper surface of the pin is preferably generally about the thickness of the material used in the sash stile or slightly less. The retaining pins are designed so that when the vent stop is snapped into the opening in the sash the pins will retain the vent stop in position and not be removed easily. The faceplate 16 is preferably formed as a solid one piece member and is configured to project only slightly forward of the front surface of the stile so as not to interfere with the relative sliding movement of the sashes. The faceplate 16 may be provided with a curved outer peripheral edge 57, however it will be appreciated that the outer peripheral edge may be any configuration besides curved as is desired.

The faceplate 16 includes a centrally located generally elongate vertical opening 58 which is in communication with an interior cavity 59 of the housing 11. The tumbler 60 is mounted within the cavity 59 to pivot therein and to lockingly engage the upper exterior surface of the lower sash header as the lower sash header is raised.

The tumbler 60 has a bottom surface 61 and a front face 62. The front face 62 is angled as shown in the Figures to permit the tumbler to easily move from an inactivated to an activated position. The spring preferably has a ring 63 that permit the spring 33 to be retained in position by a pin 64 in the underside of the tumbler. A preferred type of spring is a leaf spring shown in FIG. 13. However, it will be appreciated by those skilled in the art that other types of springs may be used.

1. A vent stop for use with a sliding member comprising:
a housing adapted to be disposed in a recess in said sliding member, said housing including a cavity;
a tumbler disposed in said cavity, said tumbler including a protruding apex at the top thereof;
pivot means for pivotally securing said tumbler to said housing for movement between an extended position where a front face of said tumbler overlies an edge of the sliding member to prevent movement of the sliding member past the front face of the tumbler, and a retracted position within said cavity where the sliding member can be moved past the tumbler;
a spring means for biasing said tumbler into said extended position; and
a release member that has a first position for causing said tumbler to be in a raised position and a second position for causing said tumbler to be retained a lowered position
wherein said housing further comprises a button which when pressed causes said release member to move from said second position to said first position thereby causing said tumbler to be in a raised position.

2. A vent stop according to claim 1 wherein the release member pivots.

3. A vent stop according to claim 1 wherein said release member has a head and the tumbler has a tip and wherein the tumbler is in a lowered position when said head contacts said tip.

4. A vent stop according to claim 3 wherein said button has a pin that contacts a face on said release member when said button is pushed.

5. The vent stop according to claim 1 wherein said sliding member is a sash in a double hung window.

6. The vent stop according to claim 1 wherein the sliding member is a sash in a window.

7. The vent stop according to claim 1 wherein the sliding member is a sash in a sliding window.

8. The vent means according to claim 1 wherein said sliding member is a door.

9. A vent stop for use with a sliding member comprising:
a housing adapted to be disposed in a recess, said housing including a cavity formed by a faceplate and first and second side walls extending from said faceplate;
a tumbler disposed in said cavity, said tumbler including a protruding apex at the top thereof;
pivot means extending from at least one of said first and second sidewalls for pivotally securing said tumbler to said housing for movement between an extended position, and a retracted position within said cavity,
a spring means for biasing said tumbler into said extended position; and
a release member for causing said tumbler to be in a raised position and a lowered position;
wherein said release member has a head that contacts said tumbler when said tumbler is in a lowered position and does not contact said tumbler when said tumbler is in a raised position.

10. The vent stop according to claim 9 wherein said sliding member is a sash in a double hung window.

11. The vent stop according to claim 9 wherein the sliding member is a sash in a window.

12. The vent stop according to claim 9 wherein the sliding member is a sash in a sliding window.

13. The vent means according to claim 9 wherein said sliding member is a door.
